(19) United States
(12) Patent Application Publication
(10) Pub. No.: US 2010/0324947 A1
(43) Pub. Date: Dec. 23, 2010

(54) System and method for creating and using energy credits derived from the construction industry while maintaining green certificateion

(76) Inventor: Aaron David Trent Needham, Washington City, UT (US)

Correspondence Address: Preston P. Frischknecht;Brent T. Winder, Jones waldo Holbrook & McDonough, 170 South Main Street, Suite 1500, Salt Lake City, UT, 84101-1644, US

(21) Appl. No.: 12/456,461

(22) Filed: Jun. 17, 2009

(51) Int. Cl. G06Q 10/00; G06Q 30/00

(52) U.S. Cl. 705/7; 705/1.1

(57) ABSTRACT

A system and method for creating and using energy credits derived from the construction sector while maintaining green certification. The system and method uses buildings. The energy consumption of a building or buildings is first reduced by identifying and placing predetermined components in the buildings. That energy reduction is then designated as an energy credit derived from and associated with the construction sector. The credit is then marketed and sold. The remaining or residual energy consumption associated with use of the building is then offset through the purchase of outside energy credits. The building or buildings are then certified as green.

### BACKGROUND OF THE INVENTION

1. Field of the Invention

The field of the invention is the carbon cap and trade, renewable energy, and energy efficiency industries.

2. Description of the Background

Reduction of carbon emissions is increasingly at the forefront of discussion in private industry, government, and the general public. It is widely acknowledged that carbon emissions generated from various sources, including the production and consumption of energy in the construction, industrial, and transportation sectors, contribute to global warming and climate change. Such effects may also result in economic loss across various industries.

According to various sources, residential and commercial buildings in the United States produce up to 39% of overall carbon emissions, making the construction sector, as defined by existing and planned buildings, a leading carbon emitter. Therefore, programs that target the construction sector's carbon emissions are critical to a focused effort to reduce overall carbon emissions.

Generally, there are several ways to reduce overall carbon emissions. There are also specific methods of reducing emissions which are unique to the construction sector. For example, at a general level, using energy more efficiently is one common way to minimize carbon emissions. Green building is a specific type of building practiced within the construction sector which uses building design to optimize energy efficiency of the building structure. In the United States, one nationally recognized program of green building is Leadership in Energy and Environmental Design (LEED). LEED certification is a specific green building certification that denotes that a building has met certain criteria for energy efficient design and that certain energy savings are being achieved. Criteria for LEED or other independent green certifications may include the use of renewable or recyclable energy, use of energy efficient products, or defining the carbon emissions of an entity and offsetting it through the purchase of energy credits.

As exemplified by its presence as LEED and other criteria, using energy generated from renewable sources is another important way to minimize carbon emissions. Renewable energy is energy generated from relatively unlimited natural resources such as solar, wind, geo thermal, hydropower, and biomass.

Other mechanisms facilitating the reduction of carbon emissions are carbon cap and trade systems. These systems allow an entity to obtain, through purchase or trade, a carbon commodity or credit, which has been generated by the energy savings or renewable energy production of others, to “reduce” or “offset” the purchasing entity's carbon emissions. The producer who originally generated the credit may also receive a benefit from such systems and programs because he or she obtains a monetary or other return when his or her commodity is sold to a buyer.

One specific example of such a carbon credit represents energy savings generated and is called an Energy Efficiency Credit (EEC) or White Tag (collectively referred to herein as an “EEC”). This credit represents 1 megawatt-hour of electricity saved in an eligible manner. Certain states in the United States have developed and administer mandatory EEC programs for public utility entities. There are also voluntary markets for EECs whereby corporate and other private entities voluntarily reduce their carbon footprint by purchasing EECs.

Another example of a carbon credit represents energy generated directly from a renewable energy source and is called a Renewable Energy Credit (REC), Green Tag, or Tradable Renewable Certificate (TRC) (collectively referred to herein as an “REC”). This credit represents 1 megawatt-hour of electricity generated from an eligible renewable energy resource. The generator of an REC may trade or sell an REC after the generated electricity is fed into the electrical grid, and the purchaser of the credit generally receives a certificate stating that he has used renewable energy.

Significantly, there is currently no nationwide system of administering and accounting for RECs, and programs differ from state to state or region to region. More particularly, the value placed on RECs, as well as rules for their creation and trading, are a function of state-specific regulatory policies known as Renewable Portfolio Standards (RPSs).

To date, certain efforts have been made to target carbon emissions resulting from the construction sector by both individuals and government entities, including the Building America Team of the Department of Energy. Indeed these groups have sought to combine green building techniques to establish a unified program whereby building owners would effectively have no net utility bill expenses. However, to date, these attempts have not fully utilized the carbon credit concepts described above, and have also been unsuccessful in their stated ambitions of achieving net zero utility bills through a unified program targeting construction sector-based carbon emissions.

Therefore, a comprehensive program targeting carbon emissions in the construction sector by both generating carbon credits derived from and associated with the construction sector, and using green building to achieve net zero utility bills has been elusive to date. Notably, from the carbon credit side, the existing carbon credit systems are inadequate for this endeavor for several reasons.

First and foremost, none of the current carbon credit systems specifically target carbon emissions generated within the construction sector, a predominant carbon emitter. While, to some extent, government programs identify RECs for emissions generated in the utility sector, existing systems for RECs and EECs do not otherwise distinguish among sectors of industries generating carbon emissions, and they certainly do not target emissions generated by the construction sector. Specifically, RECs are identified only according to generating renewable resource type and the geographical location where they were generated. Therefore, those who produce, trade, or otherwise incentivize these credits cannot ascertain whether their efforts to reduce carbon emissions are precisely aimed at a leading source of carbon emissions, as opposed to a less significant source.

Second, a standardized system of valuing and trading RECs and EECs interstate does not exist due to the fact that each state's RPS, which defines and administers RECs and EECs, is unique and reflective of the policy objectives and self-interests of that particular state. Such policy objectives and self interests include favoritism to renewable resources particular to that state. More particularly, because renewable energy sources upon which RECs are based vary from state to state, there is no single and common renewable resource generating credits from each state and there is no conforming value between the credits for each state. Therefore, incorporating RECs across and between states is currently impracticable.

For the foregoing reasons, a universal method of identifying and targeting carbon emissions produced from the construction sector by both generating a universally accepted energy credit within that sector and using green building and certification to achieve net zero utility bills is needed.

### SUMMARY OF THE INVENTION

In accordance with the above, an innovative system and method is provided. The invention sets forth a system and method for creating and using energy credits in a building and in building construction, which credits are specifically derived from the construction industry. Through combining green building techniques with a new form of energy credit, entities are ultimately able to achieve net zero utility bills while maintaining green certification for buildings.

### BRIEF DESCRIPTION OF THE FIGURES

FIG. 1 is a flowchart describing in broad terms the overall and basic steps of the system and method claimed according to one embodiment of the present invention.

FIG. 2 is a flowchart describing in specific detail the step of reducing the energy consumption of a building, according to one embodiment of the present invention, which is one of several steps of the present invention.

FIG. 3 is a flowchart describing in specific detail the step of quantifying energy reduction as an energy credit, according to one embodiment of the present invention, which is one of several steps of the present invention.

FIG. 4 is a flowchart describing in specific detail the steps of offsetting carbon emissions and certifying a building as green, according to one embodiment of the present invention, which is one of several steps of the present invention.

### DETAILED DESCRIPTION OF THE ILLUSTRATED EMBODIMENT

The present invention in its various embodiments is a system and method for creating and using energy credits in a building and in building construction, which credits are specifically derived from the construction industry, as well as maintaining green certification. More specifically, the system and method involves a process whereby the energy consumption of a building or planned building is reduced, the reduction being quantified as an energy credit derived from the construction sector, and then sold. The carbon emissions resulting from the residual energy consumption of the building is then ascertained and offset through the purchase of outside energy credits, and the building is certified as green.

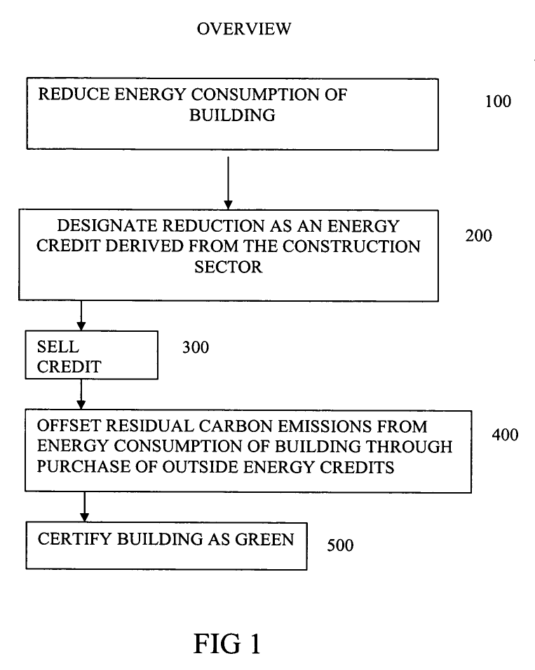

FIG. 1 is a flow chart that generally illustrates the system and method claimed by delineating the steps involved at a broad level. In one embodiment of the current invention, the steps take place as part of an overall program through which homeowners, builders, or other entities elect to participate. The preferred embodiment is largely administered as a comprehensive program by a private entity named HybridEnergyHomes™. In the preferred embodiment, HybridEnergyHomes™ administers or oversees the implementation of the system and method for other entitities as a paid service and in connection with the comprehensive program. However, any or all of the steps in the system and method may be performed by any entity in order to effectuate the system and method.

The method begins once it is determined that it is desirable for the energy consumption of or carbon emissions produced by a building or planned building be reduced. Steps are then taken to reduce the typical energy consumption of that building by a certain predetermined amount [100].

The reduction of the energy consumption is designated as an energy credit specifically derived from the construction sector [200]. In the preferred embodiment, this credit is specifically as a BlueTag™.

This credit is then marketed and sold to other entities, including those who desire to offset their own existing carbon emission production [300].

Next, the remaining carbon emissions produced from the residual energy consumption associated with the building are offset through the purchase of outside energy credits [400].

Finally, the building, which now offsets 100% of its carbon emissions, is granted green certification [500].

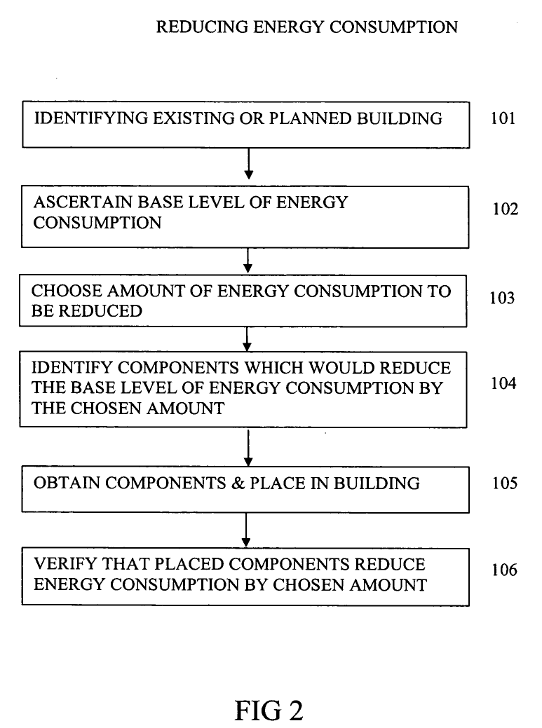

Reference to FIG. 2 is now made to begin to illustrate more specifically the steps of the claimed system and method. More particularly, FIG. 2 breaks down into subparts the critical step of reducing the energy consumption of a building. First, an existing or planned building or buildings are identified [101]. All types of buildings may be identified for participation within the system and method. Existing buildings or buildings at the conceptual or development stage may be identified. Commercial, residential, or any other building types may be included. The identification of buildings for participation may be limited to single buildings or comprehend entire developments. No particular building type is excluded under this step.

Once a building or buildings are identified, a base level of energy consumption typically produced as a result of the normal use for the building or buildings is ascertained [102]. For an existing building, this may be accomplished by any one of a number of means, including obtaining usage information from energy or utility bills, as well as by reference to other existing sources of energy usage information for the building.

In one embodiment of the invention, a base level of energy consumption is ascertained using software products, including Energy Gauge®, Micropas®, and Rem/Rate™. By inputting certain building information such as: physical dimensions; applicable building codes; physical properties and components like foundation, exterior materials, insulation, windows and exterior doors; heating and cooling systems; and electrical loads into these software programs, a user may obtain detailed performance-based analyses of building energy, including the calculation of heating, cooling, hot water, lighting, and appliance energy loads for both planned and existing buildings. Accordingly, by using either these software products or by referring to other sources, a base rate of energy usage for a building may be obtained, typically in kilowatt hours (KWh) or megawatt hours (MWh).

Once a base level of energy usage for a building is ascertained, a specific amount or range of this energy usage or consumption is chosen to be reduced below the base level [103]. In the preferred embodiment, a comprehensive program implemented by HybridEnergyHomes™, one may select between three possible ranges of energy reduction: (1) a Bronze option, whereby energy consumption will be reduced between 40% to 60% below the existing base level; (2) a Silver option, whereby energy consumption will be reduced between 60% to 75% below the existing base level; and (3) a Gold option, whereby energy consumption will be reduced between 75% to 90% below the existing base level. However, any number of ways may be utilized to quantify or select a reduction in energy consumption below the base level.

After a certain amount of energy usage or consumption is chosen to be reduced below the existing base level, various components are identified which, if utilized in the building, would bring about the reduction of energy previously chosen [104]. A precise determination of the components required to bring about the desired energy consumption reduction may be assisted by the use of the Energy Gauge®, Micropas®, and Rem/Rate™ products mentioned above. These products assist one in the choice by recommending component options based upon existing conditions and desired energy level reductions. Such components may include, but are not limited to: windows, doors, exterior wall coverings, roofing insulation, solar and wind applications, geo thermal systems, exterior patios, landscaping, water features, insulation, hvac systems, water heaters, appliances, outlets, light fixtures, window coverings or even the location and orientation of the building itself. Any number of additional components which would reduce the base level of energy consumption of a building or buildings if placed within the building or buildings may be identified.

Importantly, for the purposes of the system and method, energy reduction also includes, and is further defined by, energy production from renewable resources. Illustrated in another way, overall energy reduction for a building may be accomplished not only through energy efficiency per se, but also through solar, wind, geo thermal, or other applications which reduce overall energy consumption in a building below the base level through the production of renewable energy, which may be used in the building.

After the components are identified, some combination or all of them are obtained, and placed in the building or buildings [105]. For an existing building, this component placement may effectively include a retrofit of the existing structure by replacement of existing components with the new ones. Alternatively, component placement for an existing building may simply involve the addition of components to the existing structure. For a planned building, component placement may require components to be singularly or systematically added to the building concurrent with building construction. Similarly, some or all of the components may be placed in the building at any time subsequent to construction. The timing of component placement may vary, according to the particular embodiment utilized, and is not critical to the invention as long as they assist to achieve the south reduction in energy consumption.

Subsequent to component placement, one verifies that the placed and operating components actually reduce energy consumption below the base level in the range or specific amount previously selected [106]. Verification may be made in any number of ways as long as confirmation is made that the actual energy consumption being reduced by the placed components is in harmony with the previously chosen consumption reduction. For example, in one embodiment of the method, verification may take place by reading on-site meter devices connected to the placed components. In another embodiment, verification may be made largely off-site from on-site meter devices connected to the placed components that transmit energy consumption information.

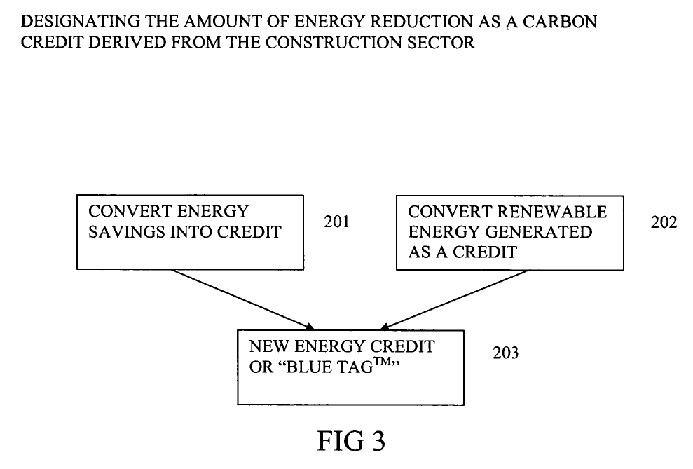

Reference to FIG. 3 is now made to further illustrate more specifically the steps of the claimed system and method. More particularly, FIG. 3 breaks down into subparts the step of designating the amount of energy reduction as a carbon credit derived from the construction sector.

Designation of the amount of energy reduction as an energy credit derived specifically from the construction industry is significant to the overall invention and also represents innovation in the field of carbon and energy credit systems. In the preferred embodiment, the energy credit is specifically designated as a BlueTag™ [203]. Criteria for the generation of a BlueTag™ energy credit specifically include energy savings specific to, and renewable energy generated within, the construction sector. A BlueTag™ therefore incorporates some elements of existing systems of carbon credits in that: (1) energy savings from placed components are converted into a credit [201], akin to an Energy Efficiency Credit (EEC), and (2) renewable energy produced from placed components is also converted into a credit [202], akin to a Renewable Energy Credit (REC). However, because the BlueTag™ is derived exclusively from and identified with the construction sector, it supercedes any relation to the EEC and REC systems by tying the carbon credit concept specifically and exclusively to carbon emissions generated within the construction sector. For example, the BlueTag™ may be used within a standardized system of valuing and trading RECs interstate, which system is, in turn, based on a single, common resource—buildings.

The precise conversion from energy reduction to energy credit is generally made by calculating the amount of MWh saved and designating the savings in MWh as an equal amount of energy credits produced. For example, if 10 MWh of energy is reduced, the savings results in 10 energy credits generated. Importantly, energy savings from such sources as gas may also be converted into an energy credit by first converting reductions in standard units of gas—such as British Thermal Units (BTUs)—to KWh or BWh, and finally to an equivalent amount of energy credits. While the precise name of the credit may vary according to different embodiments, critical to the system and method claimed is that the designation of the credit denotes the credit's derivation from and association with the construction sector.

Referring back to FIG. 1, after the energy reduction is designated an energy credit, the credit may be marketed, sold or traded [300]. Ultimately, the proceeds from any such transaction may be returned or forwarded to the owner or other responsible party associated with the building. This return may significantly offset the building owner's initial costs of participating in the system and method by providing a mechanism to reduce the up-front costs that may be incurred due to placement of components. Employing one or more cost-offsetting mechanisms also effectively achieves net-zero utility bills for the building owner because costs for any residual energy consumption related to the building are offset through the sale of energy credits.

Other cost-offsetting mechanisms may be employed in connection with the system and method, including local, state, or federal tax credits and energy efficiency mortgages. Because of increasing demand and policy incentives for energy efficiency, these and other cost-offsetting mechanisms are in a state of rapid development and flux. Therefore, cost-offsetting is not limited to the mechanisms described herein.

Finally, green certification of buildings is integral to the overall method described herein, and may often be pre-requisite to demonstrating qualification for and obtaining of the cost-offsetting mechanisms described above. Under the system and method described, criteria for green certification include the offset of 100% of carbon emissions produced from energy consumption related to normal use of the building. In the preferred embodiment of the system and method, green certification is reviewed and issued by HybridEnergyHomes™ a business located at P.O. Box 910397, St. George, Utah 84791. In order to achieve green certification, several steps are taken.

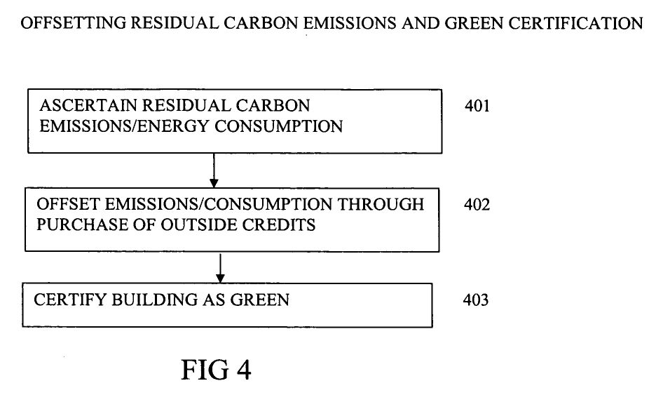

Reference to FIG. 4 is now made to further illustrate more specifically the steps of the claimed system and method. More particularly, FIG. 4 breaks down into subparts the steps of steps of offsetting carbon emissions and certifying the building as green, according to one embodiment of the present invention, which is one of several steps of the present invention.

First, the direct and indirect carbon emissions generated from the normal operation of a building or buildings must be ascertained [401]. This may be accomplished through a review of the residual energy usage of the building via utility or other bills associated with the building or via use of the software products described above. In the preferred embodiment, these residual emissions represent the remaining emissions which exist from the energy consumption of the building after considerable energy consumption measures have taken place. Accordingly, in the preferred embodiment, the remaining energy usage and, therefore, carbon emissions, will be minimal.

Once the direct and indirect carbon emissions generated from normal operation of the building are ascertained, energy credits are then purchased to offset these emissions [402]. More precisely, the amount of carbon credits required for offset is proportional to each ton of CO2 emitted. In this example of the preferred embodiment, one ton of CO2 is the equivalent of one energy credit. Once these energy credits are purchased, the building is certified as green. In the preferred embodiment, this is done by HybridEnergyHomes™.

The invention ultimately results in a system and method for a building or building construction, whereby energy credits specifically derived from the construction industry are created and sold. Through combining green building techniques with this new form of energy credit, entities are able to achieve net zero utility bills while maintaining green certification in a manner which cannot be achieved by current carbon credit systems.

1. A method for creating and using energy credits, said credits being derived from the construction industry, while also maintaining green certification, comprising the steps of:
a. Identifying a building;
b. Ascertaining a base level of energy consumption for normal use of said building;
c. Choosing to reduce said base level of energy consumption by a certain amount;
d. Identifying components, which, if placed in said building, would reduce said base level of energy consumption of said building by said certain amount;
e. Obtaining said components;
f. Placing said components in said building;
g. Verifying that said placed components reduce said energy consumption of said building by said certain amount;
h. Designating said certain amount as an energy credit;
i. Ascertaining direct and indirect carbon emissions generated from normal operation of said building;
j. Purchasing energy credits to offset said direct and indirect carbon emissions generated from said building; and
k. Certifying said building as green.

2. The method of claim 1 further comprising the step of marketing said energy credit to potential purchasers of the energy credit.

3. The method of claim 1 further comprising the step of exchanging said energy credit for a monetary value.

4. The method of claim 1 wherein the step of identifying a building comprises identifying a home.

5. The method of claim 1 wherein the step of identifying a building comprises identifying a commercial building.

6. The method of claim 1 wherein the steps of identifying, obtaining, and placing components comprises identifying, obtaining, and placing components from the group consisting of windows, doors, exterior wall coverings, roofing insulation, solar and wind applications, geo thermal systems, exterior patios, landscaping, water features, insulation, hvac systems, water heaters, appliances, outlets, light fixtures, window coverings, and building location.

7. The method of claim 6 wherein the step of verifying comprises on-site inspection of the performance of said components.

8. The method of claim 7 wherein on-site inspection is conducted by reading monitoring devices connected to said components.

9. The method of claim 1 wherein the step of verifying comprises off-site inspection of the performance of said components.

10. The method of claim 9 wherein off-site inspection is conducted by collecting data from transmitting monitoring devices which are connected to said components on-site.

11. The method of claim 1 wherein the steps of the method are performed directly as a service by a single business entity.

12. The method of claim 1 wherein the steps of the method are performed indirectly as a service by a single business entity.

13. A method of creating energy credits in building construction, said credits being derived from the construction industry, while also maintaining green certification for said building construction comprising the steps of:
a. Identifying a building construction development in its planning stages;
b. Identifying a planned building within the building construction development;
c. Ascertaining a base level of energy consumption for normal use of said planned building;
d. Choosing to reduce said base level of energy consumption by a certain amount;
e. Identifying components compatible with said planned building which, if utilized, would reduce the energy consumption of said building by said certain amount;
f. Obtaining said components;
g. Constructing said building;
h. Placing said components in said building;
i. Verifying that said placed components reduce said energy consumption of the building by the said certain amount;
j. Designating said certain amount as an energy credit;
k. Ascertaining direct and indirect carbon emissions generated from normal operation of said building;
l. Purchasing energy credits to offset said direct and indirect carbon emissions generated from said building; and
m. Certifying said building as green.

14. The method of claim 13 further comprising the step of marketing said energy credit to potential purchasers of the credit.

15. The method of claim 13 further comprising the step of exchanging said energy credit for a monetary value.

16. The method of claim 13 wherein the step of identifying a building comprises identifying a home.

17. The method of claim 13 wherein the step of identifying a building comprises identifying a commercial building.

18. The method of claim 13 wherein the steps of identifying, obtaining, and placing components comprises identifying, obtaining, and placing components from the group consisting of windows, doors, exterior wall coverings, roofing insulation, solar and wind applications, geo thermal systems, exterior patios, landscaping, water features, insulation, hvac systems, water heaters, appliances, outlets, light fixtures, window coverings, and building location.

19. The method of claim 13 wherein the step of verifying comprises on-site inspection of the performance of said design components.

20. The method of claim 19 wherein on-site inspection is conducted by reading monitoring devices connected to said design components.

21. The method of claim 13 wherein the step of verifying comprises off-site inspection of the performance of said design components.

22. The method of claim 21 wherein off-site inspection is conducted by collecting data from transmitting monitoring devices which are connected to said design components on-site.

23. The method of claim 13 wherein the steps of the method are performed directly as a service by a single business entity.

24. The method of claim 13 wherein the steps of the method are performed indirectly as a service by a single business entity.
